(19) United States
(12) Patent Application Publication
(10) Pub. No.: US 2017/0050463 A1
(43) Pub. Date: Feb. 23, 2017

(54) SINGLE PIECE WHEEL RIM

(71) Applicant: TITAN STEEL WHEELS LIMITED, Worcestershire (GB)

(72) Inventors: Stephen John Arnold, Worcestershire (GB); Stephen James Lewis, Worcestershire (GB)

(21) Appl. No.: 15/113,991

(22) PCT Filed: Jan. 23, 2015
(86) PCT No.: PCT/GB2015/050154

§ 371 Date: Jul. 25, 2016

(30) Foreign Application Priority Data
Jan. 23, 2014 (GB) 1401094.6

(51) Int. Cl. B60B 3/04; B21D 53/30; B60B 25/00

(52) U.S. Cl. CPC B60B 3/041; B60B 25/002; B21D 53/30; B60B 2310/206; B60B 2310/228; B60B 2310/302; B60Y 2200/15

(57) ABSTRACT

A method of manufacturing a wheel sub-assembly for a wheel of a very large vehicle, such as those used for mobile cranes, quarry excavation or transport of mined material. The method includes providing first and second cylindrical blank components and an annular disc blank; press forming the first blank component to form a one piece, axially outer rim portion; press forming the second blank component to form a one piece, axially inner rim portion; circumferentially Joining, the outer and inner rim portions to form an annular wheel rim having a base; machining the inside diameter of the wheel rim base; press forming the disc blank to form a press-formed disc; machining the outside edge of the press-formed disc; press fitting the press-formed disc to the wheel rim base at the machined inside diameter; and welding the press-formed disc to the wheel rim base at the machined inside diameter.

The present invention relates to a method of manufacturing a wheel sub-assembly for a vehicle. More specifically the present invention relates to a method of manufacturing a wheel sub-assembly for a very large vehicle.

Very large vehicles, such as those used for mobile cranes, quarry excavation or transport of mined material have large diameter wheels. These are bigger than the wheel's of road going heavy goods vehicles (HGVs). Commonly, given their working environment, these types of vehicles are required to operate on unpaved routes, often termed “off-road”. Such vehicles require therefore a robust wheel rim and tyre combination.

Known methods for manufacturing wheel rims include single piece wheel rims manufactured using circular rolling techniques for use on commercial vehicles, agricultural vehicles and light construction vehicles. These types of vehicles, however, have relatively small diameter wheel rims, such that relatively thin material may be used in the circular rolling technique.

The wheel rim diameters required for the very large vehicles mentioned above are not produced by these known methods.

A known method for producing wheel sub-assemblies with rims of the diameter required for very large vehicles is through the use of multi-piece rims. Each circular wheel rim is made from three equal segments, approximating 120° each and joined radially by bolting.

A disadvantage of multi-piece rims is that they require loose parts to be in contact with the pneumatic tyre.

The present invention aims to address one or more of the above problems.

According to a first aspect of the present invention there is provided a method of manufacturing a wheel sub-assembly for a wheel of a very large vehicle, the wheel having an axis of rotation, the method comprising the steps of:
providing a first cylindrical blank component, a second cylindrical blank component and an annular disc blank;
press forming the first blank component to form a one piece, axially outer rim portion;
press forming the second blank component to form a one piece, axially inner rim portion;
jointing the outer and inner rim portions to form an annular wheel rim having a base;
machining the inside diameter of the wheel rim base;
press forming the disc blank to form a press-formed disc;
machining the outside edge of the press-formed disc;
press fitting the press-formed disc to the rim base at the machined inside diameter;
welding the press-formed disc to the rim base at the machined inside diameter.

By using a multi-step press forming method, thicker material can be used for the rim compared with conventional rim rolling methods, allowing wheel rims for very large vehicles to be produced. A single piece rim portion, i.e. defining a full circumference, does not have any loose parts in contact with the pneumatic tyre. Furthermore, by press-forming the rim as two separate portions (an inner rim portion and an outer rim portion) a rim asymmetry can more easily be catered for in production. A greater depth of rim well is also achieved, which supports the use of large pneumatic tyres. By press forming the disc separately and subsequently joining to the wheel rim, manufacturing operations on the inner rim portion, outer rim portion and disc may be performed in parallel, improving the efficiency of the manufacturing operation.

The step of press forming the first blank component to form an outer rim portion may comprise multiple press forming operations.

The method of manufacturing a wheel sub-assembly for a wheel of a very large vehicle may further include the step of machining a valve hole into the outer rim portion.

The method of manufacturing a wheel sub-assembly for a wheel of a very large vehicle may further include the step of machining a valve hole into the inner rim portion.

The method of manufacturing a wheel sub-assembly for a wheel of a very large vehicle may further include the step of machining a detail on the outer rim portion and machining a corresponding detail on the inner rim portion so that when the outer and inner rim portions are joined those details substantially interlock.

According to a second aspect of the present invention there is provided a method of manufacturing a wheel for a very large vehicle, comprising the steps of manufacturing a wheel sub-assembly as hereinbefore described, and comprising the further step of arranging a pneumatic tyre to surround and seat in the outer and inner rim portions of the wheel sub-assembly.

According to a third aspect of the present invention there is provided a wheel sub-assembly having an axis of rotation for a very large vehicle comprising:
a wheel rim; and
a disc;
   said wheel rim comprising an axially outer and an axially inner rim portion press formed from first and second blank components respectively and joined together to form a wheel rim having a wheel rim base, said disc comprising a press formed disc blank having a machined outer edge, press fitted and welded to a machined inside diameter of the wheel rim base.

A single piece rim does not have any loose parts in contact with the pneumatic tyre. Furthermore, rounder and more accurate wheel assemblies can be manufactured more easily and are particularly suitable for highway use, allowing very large vehicles to transit between work sites.

Additional profile changes may easily be accommodated by press tool changes, rather than adding a dedicated rim rolling stand as would be required in known rim rolling production lines.

According to a fourth aspect of the present invention there is provided a wheel for a very large vehicle comprising a wheel sub-assembly as hereinbefore described and further comprising a pneumatic tyre surrounding and seated in the outer and inner rim portions of the wheel sub-assembly.

The invention will now be described, by way of example only, and with reference to the following figures, in which:

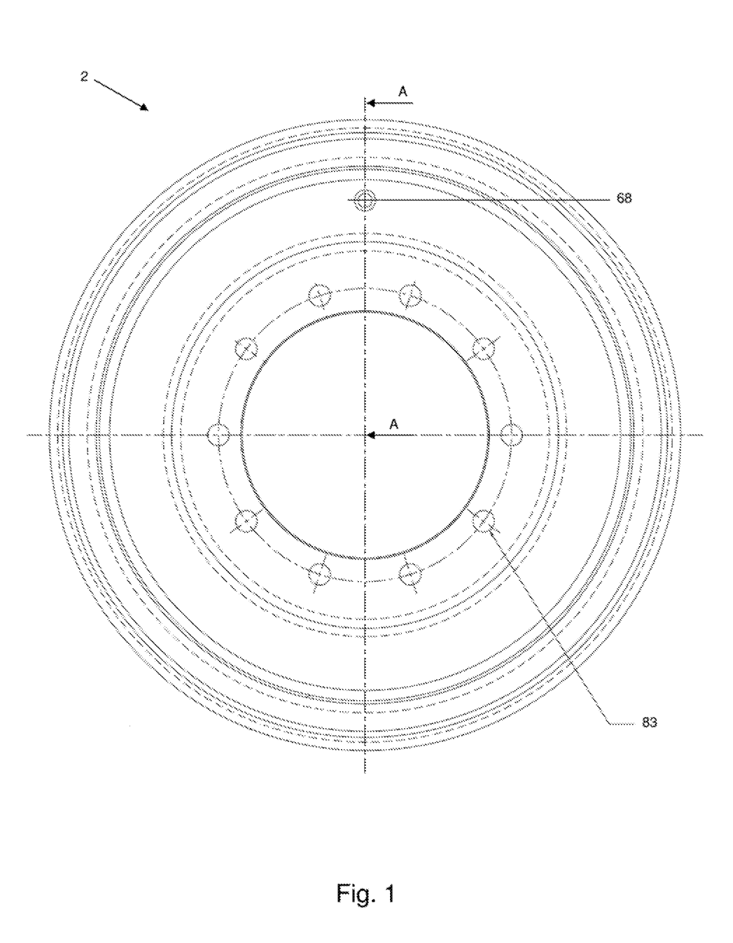

FIG. 1 is a side elevation of the wheel sub-assembly of the present invention;

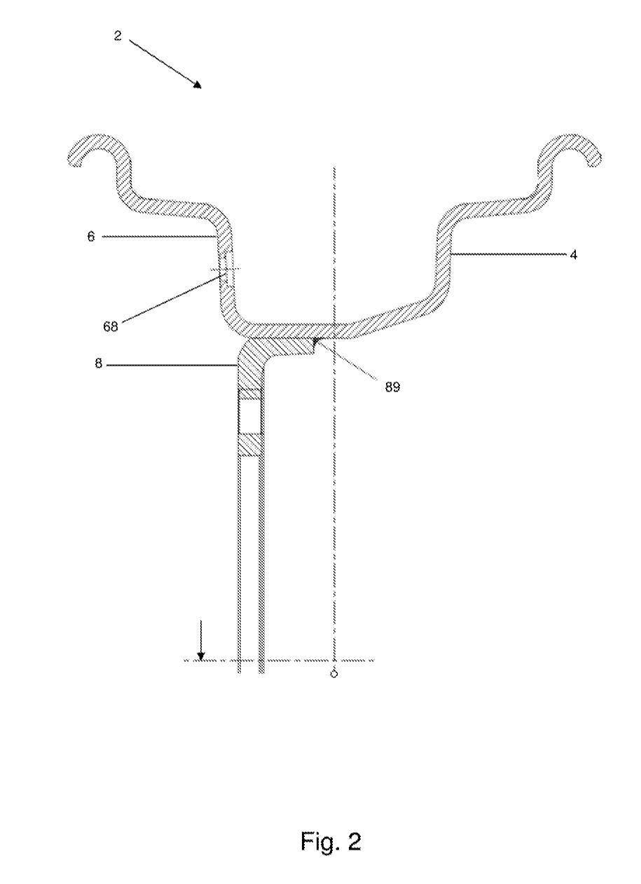

FIG. 2 is a partial cross-sectional view of the wheel sub-assembly of FIG. 1 taken at line A-A;

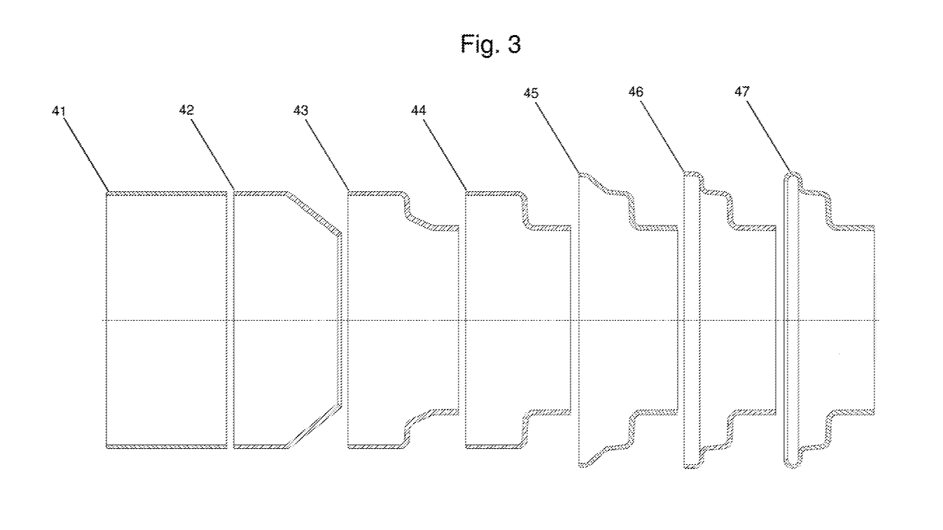

FIG. 3 is a series of section views showing the press forming sequence of the outer rim;

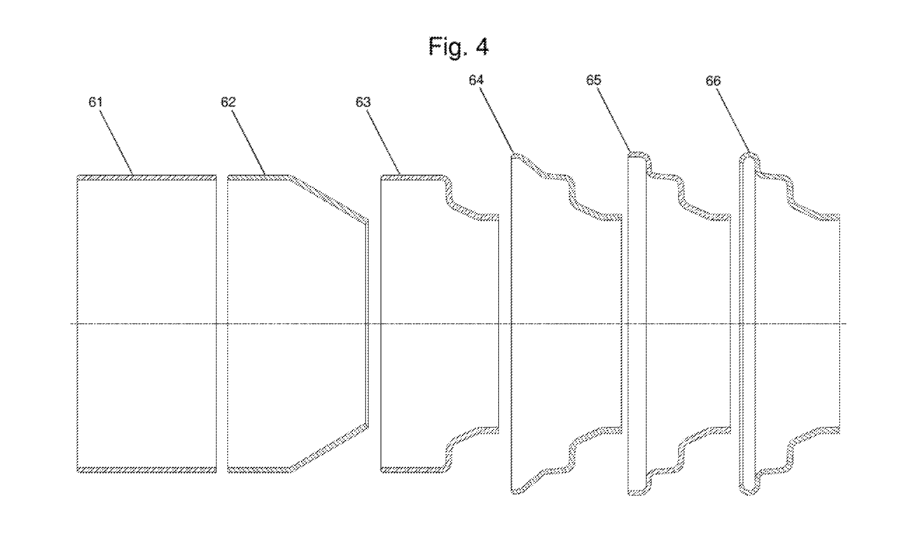

FIG. 4 is a series of section views showing the press forming sequence of the inner rim;

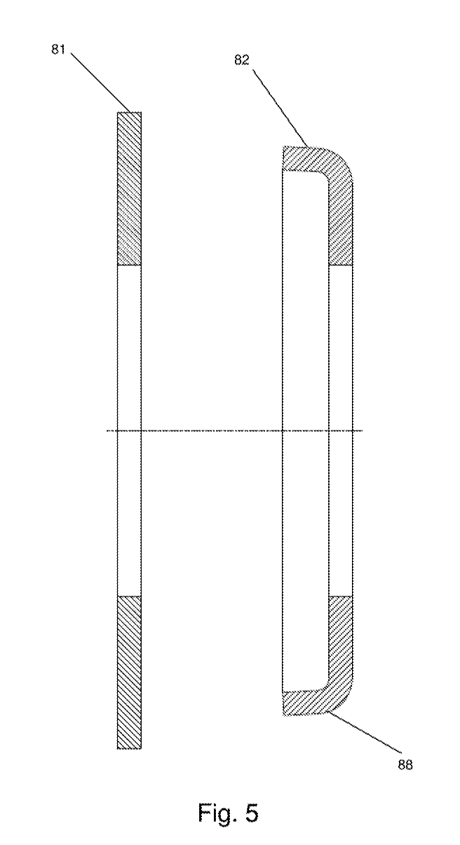

FIG. 5 is a series of section views showing the press forming sequence of the disc;

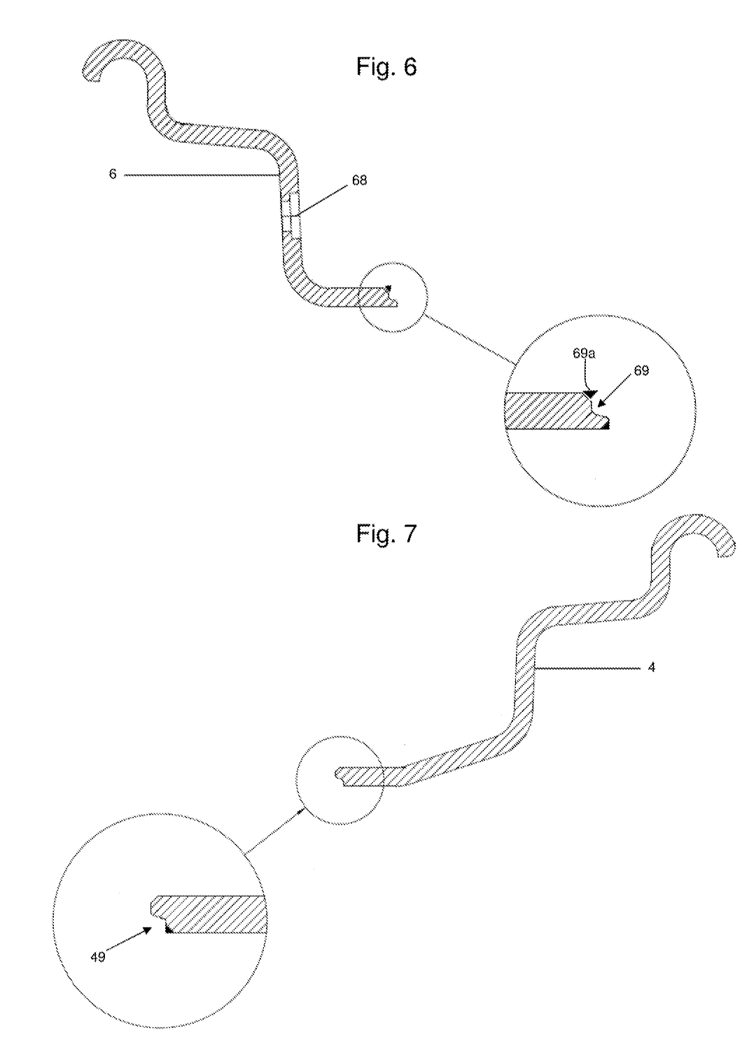

FIG. 6 is a sectional view of the outer rim of FIG. 3;

FIG. 7 is a sectional view of the inner rim of FIG. 4.

A circular wheel rim assembly 2 having an external diameter of 721 mm is shown in FIG. 1.

A cross-section taken at line A-A (see FIG. 2) shows that the wheel sub-assembly 2 comprises three principal components, an axially inner rim portion 4, an axially outer rim portion 6 and a disc 8.

The inner rim portion 4 is a press-formed annulus made in a press tool using a series of six press operations 42, 43, 44, 45, 46, 47 (see FIG. 3) on the inner rim blank 41.

Similarly, the outer rim portion 6 is a press-formed annulus made in a press tool using a series five of press operations 62, 63, 64, 65, 66 (see FIG. 4) on the outer rim blank 61.

The outer rim portion 6 additionally includes valve hole 68.

The disc blank 81 is an annulus, which undergoes a single press operation 82 (see FIG. 5) to create a disc 8 with a diameter of 440 mm at its outside edge 88. The disc 8 includes 10 equally circumferentially-spaced wheel hub holes 83 for attachment to the axle of a vehicle (not shown).

The press formed parts are assembled to form the wheel sub-assembly 2 as follows:

The inner rim portion 4 and outer rim portion 6 both include a machined detail 49, 69 (see FIGS. 6 and 7), which interlock when the inner rim portion 4 and outer rim portion 6 are circumferentially joined, forming a wheel rim base. A circumferential weld 69a is applied at this interface. The wheel rim base defines a wheel well with a width of 280 mm and a depth of 200 mm for locating the pneumatic tyre (not shown).

The inside diameter of the wheel rim base is machined on the outer rim portion side of the wheel rim base. The outside edge 88 of the press formed disc is machined. The disc 8 and wheel rim base are fitted together at these machined surfaces and a circumferential weld 89 is applied at this interface.

1. A method of manufacturing a wheel sub-assembly for a wheel of a very large vehicle, the wheel having an axis of rotation, the method comprising the steps of:
providing a first cylindrical blank component, a second cylindrical blank component and an annular disc blank;
press forming the first blank component to form a one piece, axially outer rim portion;
press forming the second blank component to form a one piece, axially inner rim portion;
circumferentially joining the outer and inner rim portions to form an annular wheel rim having a base;
machining the inside diameter of the wheel rim base;
press forming the disc blank to form a press-formed disc;
machining the outside edge of the press-formed disc;
press fitting the press-formed disc to the wheel rim base at the machined inside diameter;
welding the press-formed disc to the wheel rim base at the machined inside diameter.

2. A method of manufacturing a wheel sub-assembly for a very large vehicle according to claim 1 wherein the step of press forming the first blank component to form an outer rim portion comprises multiple press forming operations.

3. A method of manufacturing a Wheel sub-assembly for a very large vehicle according to claim 1 wherein the step of press forming the second blank component to form an inner rim portion comprises multiple press forming operations.

4. A method of manufacturing a wheel sub-assembly for a very large vehicle according to claim 1 further including the step of machining a valve hole into the outer rim portion.

5. A method of manufacturing a wheel sub-assembly for a very large vehicle according to claim 1 further including the step of machining a valve hole into the inner rim portion.

6. A method of manufacturing a wheel sub-assembly for a very large vehicle according to claim 1 further including the step of machining a detail on the outer rim portion and machining a corresponding detail on the inner rim portion so that when the outer and inner rim portions are joined the details substantially interlock.

7. A method of manufacturing a wheel sub-assembly for a very large vehicle according to claim 1 wherein the step of machining the inside diameter of the rim base is on the outer rim portion.

8. A method of manufacturing a wheel for a very large vehicle, comprising the steps of manufacturing a wheel sub-assembly according to claim 1, and comprising the further step of arranging a pneumatic tyre to surround and seat in the outer and inner rim portions of the wheel sub-assembly.

9. A wheel sub-assembly having an axis of rotation for a very large vehicle comprising:
a wheel rim; and
a disc;
said wheel rim comprising an axially outer and an axially inner rim portion press formed from first and second blank components respectively and joined together to form a wheel rim having a wheel rim base, said disc comprising a press formed disc blank having a machined outer edge, press fitted and welded to a machined inside diameter of the wheel rim base.

10. A wheel fur a very large vehicle comprising a wheel sub-assembly according to claim 9 and further comprising a pneumatic tyre surrounding and seated in the outer and inner rim portions of the wheel sub-assembly.
